(19) United States
(12) Patent Application Publication
(10) Pub. No.: US 2018/0335934 A1
(43) Pub. Date: Nov. 22, 2018

(54) TEST AND MEASUREMENT DEVICE, TEST AND MEASUREMENT SYSTEM AND METHOD FOR TESTING A DEVICE UNDER TEST

(71) Applicant: Rohde & Schwarz GmbH & Co. KG, Munich (DE)

(72) Inventor: Martin Leibfritz, Aying (DE)

(73) Assignee: Rohde & Schwarz GmbH & Co. KG, Munich (DE)

(21) Appl. No.: 15/601,025

(22) Filed: May 22, 2017

(51) Int. Cl. G06F 3/0484; G01D 18/00

(52) U.S. Cl. CPC G06F 3/04847; G01D 18/00; G06F 3/04842

(57) ABSTRACT

A test and measurement device for a device under test is described, the test and measurement device comprising a processing unit for providing data of a graphical user interface with several user interface screen portions and a display for displaying these screen portions generated by the processing unit. The processing unit is configured to provide a first user interface screen portion, a second user interface screen portion, and a third user interface screen portion. The test and measurement device further comprises a controller, the controller being configured to perform a completely automated configuration of the test and measurement device in response to the inputs and selections of the user via the user interface screen portions. The controller is further configured to provide a proposed setup for interfacing the device under test with the test and measurement device. In addition, a test and measurement system and a method for testing a device under test are described.

### FIELD OF THE DISCLOSURE

Embodiments of the present disclosure relate generally to a test and measurement device for a device under test, a test and measurement system as well as a method for testing a device under test.

### BACKGROUND

Test and measurement devices such as network analyzers, for instance a vector network analyzer (VNA), are typically operated in an operation mode that relates to an expert operation mode. This means that the test and measurement device provides the internal hardware and the corresponding options of intervention, but the user has to know the test and measurement device in order to ensure an optimal setup and configuration.

Further, test and measurement devices are known that provide a graphical user interface (GUI) on a display for guiding a user during a setup of a signal measurement system. For instance, such a graphical user interface is described in U.S. Pat. No. 4,875,859. It is known that the user is enabled to select a certain type of the device under test to be tested via the graphical user interface wherein the user may also select the type of a measurement to be performed. In addition, the test and measurement device may provide information to the user with regard to a proper setup of the device under test, for instance the several connections required. This information can be displayed on the display of the test and measurement device. Moreover, the user is inquired to set parameters being specific for the device under test to be measured such as start and stop frequencies, power levels and so on. Afterwards, the test and measurement device known in the prior art uses default values (“calibration standard” and “configuration standard”) that are associated with the selected measurement on the specified device under test. Supplementary or alternatively, the user is asked to input further information in order to calibrate the test and measurement system appropriately, in particular the test and measurement device.

Hence, the exact calibration of the whole test and measurement system has to be done at least partly manually in order to retrieve accurate measurement data. Otherwise, the test and measurement device shown in the prior art only takes default values into account depending on the selected type of measurement and the selected device under test resulting in less accurate measurements. Thus, the user still has to know internal details of the test and measurement device used in order to ensure an optimal setup and configuration of the test and measurement system.

### SUMMARY

Accordingly, there is a need for a test and measurement device, a test and measurement system and a method for testing a device under test that ensure an easy setup and configuration of the device under test ensuring user being less experienced are able to perform accurate measurements.

To address this need, among others, the present disclosure provides examples of a test and measurement device for a device under test. The test and measurement device comprises a processing unit for providing data of a graphical user interface having several user interface screen portions and a display for displaying the user interface screen portions generated by the processing unit. The processing unit is configured to provide:

a first user interface screen portion to the user that comprises a plurality of selectable types of devices under test;

a second user interface screen portion to the user, the second user interface screen portion providing a plurality of selectable parameters for measurement of the selected device under test; and

a third user interface screen portion to the user, the third user interface screen portion providing controls for input of data being specific for the device under test;

the test and measurement device further comprising a controller that is configured to perform a completely automated configuration of the test and measurement device in response to the inputs and selections of the user in the first through third user interface screen portions. The controller is further configured to provide a proposed setup for interfacing the device under test with the test and measurement device.

Further, a test and measurement system is provided that comprises a device under test to be tested and a test and measurement device as described above.

It has been found that a completely automatic configuration of the test and measurement device is possible due to the selections and inputs done by the user in the first through third user interface screen portions such that highly accurate measurements can be done in an appropriate manner. The automatic configuration comprises the configuration of the internal hardware as well as the software for performing the measurement intended. Hence, it is not necessary that the user has to know the test and measurement device, in particular the internal components, for setting up the configuration in an appropriate manner. In other words, the user does not have to be an expert in either the test and measurement device itself or the measurement to be performed in order to setup the hardware and the software of the test and measurement device as this is done automatically. Accordingly, the graphical user interface, in particular the different user interface screen portions, do not request any information about the test and measurement device itself. In fact, only parameters for measurement, the type of device under test and data regarding the device under test are requested. The necessary information of the test and measurement device is internally stored and can be accessed by the controller and/or the processing unit in order to automatically calibrate the test and measurement device. In general, the graphical user interface provides a query process for obtaining the information required in order to automatically calibrate the test and measurement device, in particular the test and measurement system comprising the test and measurement device as well as the device under test. The query process is established by a wizard-like process.

In general, the completely automated configuration may be performed by the test and measurement device, in particular its processing unit and/or controller, while calculations are done taking the inputs of the user into account. For instance, formulas are stored comprising variables relating to the inputs (required) by the user such that the variables are set appropriately. The formulas may be provided due to the fact that the internal components of the test and measurement device are known, in particular their characteristics.

The formulas may be preset by the manufacturer of test and measurement device. Alternatively or supplementary, an expert is enabled to adapt the formulas appropriately. Thus, a service technician may adjust the pre-setting of the test and measurement device while adapting the formulas such that the inputs of the user are processed differently which results in an alternative automated configuration.

Alternatively or supplementary, the actual best configurations for each potential combination are stored as pre-settings. The pre-settings might be adapted appropriately, in particular automatically, while taking the inputs of the user into account. In general, the combinations may relate to the device under test and the measurement parameters intended.

The actual best configuration can be overwritten each time a better configuration has been approved, for instance by the user. Thus, the best configuration is restored once the same device under test is used and the same measurement(s) shall be performed. If the user adapts any inputs with regard to the prior one, the configuration is adapted accordingly.

However, the test and measurement device is configured such that a completely automated configuration is performed while taking the inputs of the user into account. The inputs may be used to calculate the settings by using appropriate formulas or by adapting the pre-settings that refer to the actual best configuration.

Depending on the configuration or set-up of the whole test and measurement system, in particular the connections between the test and measurement device and the device under test, different formulas may be used for generating a data set used for configuration or calibration wherein the data set inter alia depends on the measurements intended, the specific device under test and further inputs of the user.

In a first step, the user may be inquired by the graphical user interface to enter information concerning the characteristics of the device under test to be tested by means of the first user interface screen portion. Hence, the (main) function to be tested is inquired as a device under test may have different functions to be tested. For instance, a satellite converter module comprises as a main function a frequency conversion even though it also has a power amplifying function.

In a second step, the user selects the measurement parameters, also called parameters for measurement, being of interest. This step is provided by means of the second user interface screen portion. For instance, the user may select scattering parameters (S-parameters), intermodulation or noise figure as a parameter for measurement.

Depending on these different inputs of the user, the test and measurement device, in particular its processing unit that processes the inputs of the user, inquiries dedicated information of the device under test. This information obtained may comprise basic information like start and stop frequencies, power of the device under test and other suitable information.

Afterwards, the test and measurement device generates a data set used for configuration or calibration of the test and measurement device itself such that highly accurate and useful measurements can be done by using the test and measurement device. In other words, the test and measurement device may set its internal parameters appropriately in order to self-calibrate the test and measurement device such that highly accurate measurements are retrieved. The user provides the information required, also called identification data or characteristics of the device under test to be tested, such that the self-calibration or self-configuration is possible without the need of inputting data concerning the test and measurement device itself. Thus, the user does not need to be an expert of the test and measurement device for configuring the test and measurement system in an appropriate manner.

For instance, the user may input the noise figure to be expected, a typical amplification of the device under test such that the test and measurement device, in particular its processing unit, adjusts the internal level plan as part of the configuration in order to retrieve an optimal signal-to-noise ratio/trace noise with regard to an optimal measurement speed.

Generally, the different user interface screen portions may be displayed simultaneously. Alternatively, the different user interface screen portions are displayed subsequently. For instance, other information is displayed with a certain user interface screen portion. However, a user interface screen portion may also provide a whole user interface screen.

The second user interface screen portion may be provided after selection of a certain device under test in the first user interface screen portion. Further, the third user interface screen portion may be provided after selection of at least one parameter for measurement in the second user interface screen portion. Alternatively, the user interface screen portions are presented in any order. Thus, the user may also select a desired type of measurement at the beginning, in particular selecting parameters for measurement.

The controls for input may comprise drop-down menus, value inputs, checkboxes, buttons and other types of providing information requested.

According to an aspect, the processing unit generates a fourth user interface screen portion for the user, the fourth user interface screen portion inquiring information about the main objective of the testing. This main objective is used for calibrating the test and measurement device while ensuring that the main objective is obtained in an optimal manner. For instance, tradeoff, measurement speed or measurement accuracy of the measurement is the main objective. The input regarding the main objective can be taken into account while calibrating or configuring the test and measurement device.

According to a certain embodiment, the test and measurement device is configured to enable selection of several parameters for measurements simultaneously. Thus, the test and measurement device can be set appropriately for performing different measurement simultaneously or subsequently wherein the calibration is done only once for the different types of measurements. The several measurements may be done via one channel of the test and measurement device (subsequent mode) or by different channels (simultaneous mode). Therefore, the test and measurement device itself determines the optimal settings for performing the different measurements input. Accordingly, a fast calibration or configuration is provided as the test and measurement device has to be configured only once even though different measurements are intended. The configuration done automatically corresponds to the best tradeoff in order to obtain the desired information (main objective).

Further, the test and measurement device may be configured to inquire the user to check whether certain configuration/calibration steps may be skipped in order to obtain a faster configuration/calibration even though the accuracy of the measurement would be limited while doing so.

The inputs may comprise at least one of basic information, optional parameters, specifications and expected data of the device under test. This information may be inquired by using the query process in an appropriate manner.

In some embodiments, the optional parameters are identified in the third user interface screen portion as optional ones. Therefore, the user is enabled to check which of the information required is more relevant than the others.

In addition, the controller may be further configured to provide setup information in the display about the proposed setup for interfacing the device under test with the test and measurement device. The additional information displayed can be used as guidance for the user. Inexperienced users are guided in a demonstrative way.

For instance, the setup information consists of instructions to the user. Hence, the user is instructed to perform a setup as displayed on the display of the test and measurement device. This ensures that the test and measurement device, in particular the processing unit, can ensure that the setup is done as expected. Thus, the calibration/configuration process can be performed based upon the proposed setup.

Moreover, the controller may be further configured to create a proposed calibration protocol in response to user inputs and selections in the user interface screen portions, the proposed calibration protocol efficiently calibrating the test and measurement device for each measurement requested by the user. Accordingly, the user does not have to come up with this own calibration process as the test and measurement device itself creates an efficient calibration process without repeating the use of certain connected equipment, for instance a power meter.

In some embodiments, the controller is further configured to provide calibration information about the proposed calibration process to the user in the display. Thus, the user is able to gather the corresponding information. This information may comprise instruction for an optimized calibration. Thus, the user can learn how to calibrate such a system. Moreover, standard commands for programmable Instruments commands (SCPI commands) may be generated as part of the calibration information provided.

Generally, the test and measurement device may be configured to propose a certain configuration that is displayed to the user. Thus, the user, in particular an experienced user, can verify the proposed configuration.

Moreover, the controller may be configured to provide a dedicated test plan for the device under test. For instance, several parameters for measurement are selected. Hence, the test and measurement device itself determines a sequence of the different measurements to be done ensuring best measurement results for the several parameters for measurement selected.

In addition, the controller may be configured to export the test plan to the user. Thus, the user can check and verify the different steps.

Further, the disclosure relates, among others, to a method for testing a device under test by using a test and measurement device, with the following steps:

providing a device under test;

providing a test and measurement device;

selecting a type of device under test on a graphical user interface of the test and measurement device;

selecting at least one parameter for measurement of the selected device under test;

inputting data being specific for the device under test;

performing a completely automated configuration of the test and measurement device in response to the inputs and selections of the user in the first through third user interface screen portions; and

providing a proposed setup for interfacing the device under test with the test and measurement device.

This method ensures that a test and measurement device is configured completely automatically such that a user having no experience is enabled to perform measurement intended by using the test and measurement device.

According to an aspect, information about the main objective of the testing is inquired. Hence, the user is asked to input information with regard to his main objective. The main objective of the testing may correspond to the main function of the device under test that has been selected previously. For instance, high accuracy, high measurement speed or tradeoff is a main objective.

Moreover, several parameters for measurement may be selected simultaneously. Thus, the completely automatic configuration of the test and measurement device is done with respect to the several parameters for measurement to be tested. The different measurements can be done simultaneously or subsequently. The test and measurement device itself determines the optimal settings in order to perform the different measurements.

Furthermore, setup information of a proposed setup may be provided for interfacing the device under test with the test and measurement device. The user may obey the setup information provided in order to ensure the correct setup of the whole test and measurement system comprising the test and measurement device as well as the device under test.

Furthermore, a proposed calibration protocol may be provided by means of the test and measurement device in response to user inputs and selections, the proposed calibration protocol efficiently calibrating the test and measurement device for each measurement requested by the user. Therefore, the user does not have to provide an own calibration protocol as this is done automatically by the test and measurement device.

Calibration information about the protocol calibration process may be provided to the user. For instance, the calibration information is displayed on the display of the test and measurement device such that the user is instructed in an appropriate and illustrative manner.

Moreover, the test and measurement device may be established by a test and measurement device as described above. The advantages mentioned above also apply for the method in a similar manner.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a schematic overview of a test and measurement system according to the present disclosure comprising a device under test and a test and measurement device according to the present disclosure;

FIG. 2 shows a first user interface screen portion of the graphical user interface;

FIG. 3 shows a second user interface screen portion of the graphical user interface;

FIG. 4 shows a third user interface screen portion of the graphical user interface; and

FIG. 5 schematically shows a flow-chart indicating the method for testing a device under test according to the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

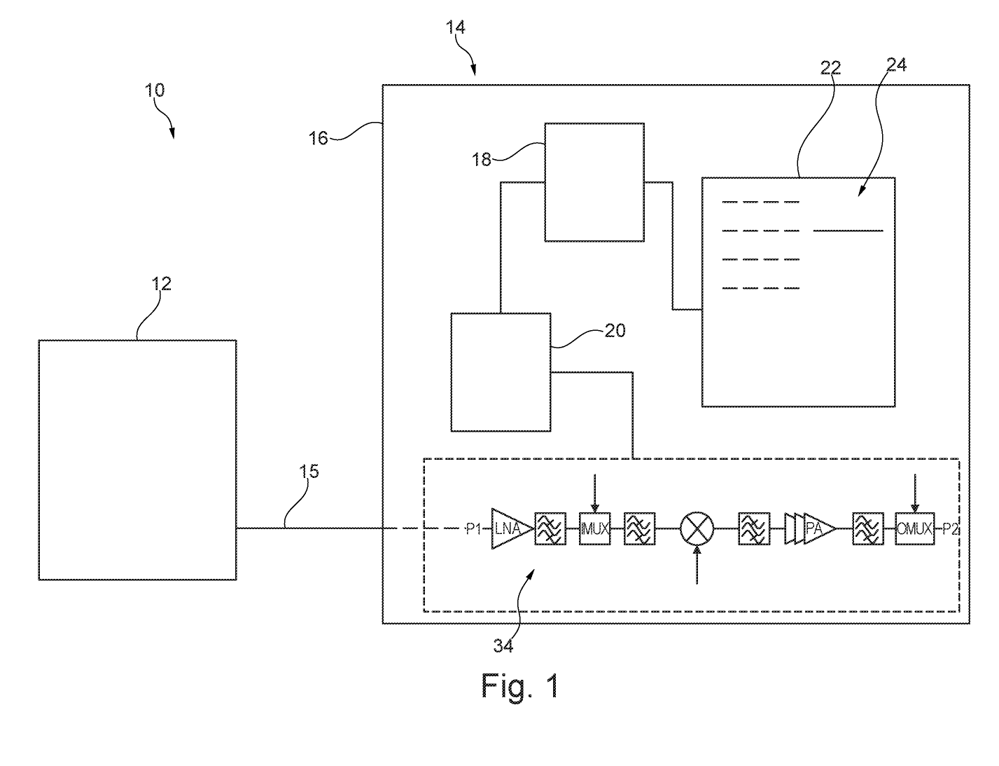

In FIG. 1, a test and measurement system 10 is shown that comprises a device under test 12 and a test and measurement device 14. The device under test 12 and the test and measurement device 14 are connected with each other via a line 15, for instance. The test and measurement system 10 is used to perform measurements on the device under test 12 wherein different types of measurements can be performed.

The test and measurement device 14 that is used for performing the different measurements comprises a housing 16 that encompasses a processing unit 18 and a controller 20 that are connected with each other. Further, the test and measurement device 14 has a display 22 for displaying information provided by the processing unit 18. Generally, the display 22 is configured to display a graphical user interface 24 which data is provided by the processing unit 18. Therefore, the display 22 may be configured as a touch-sensitive display.

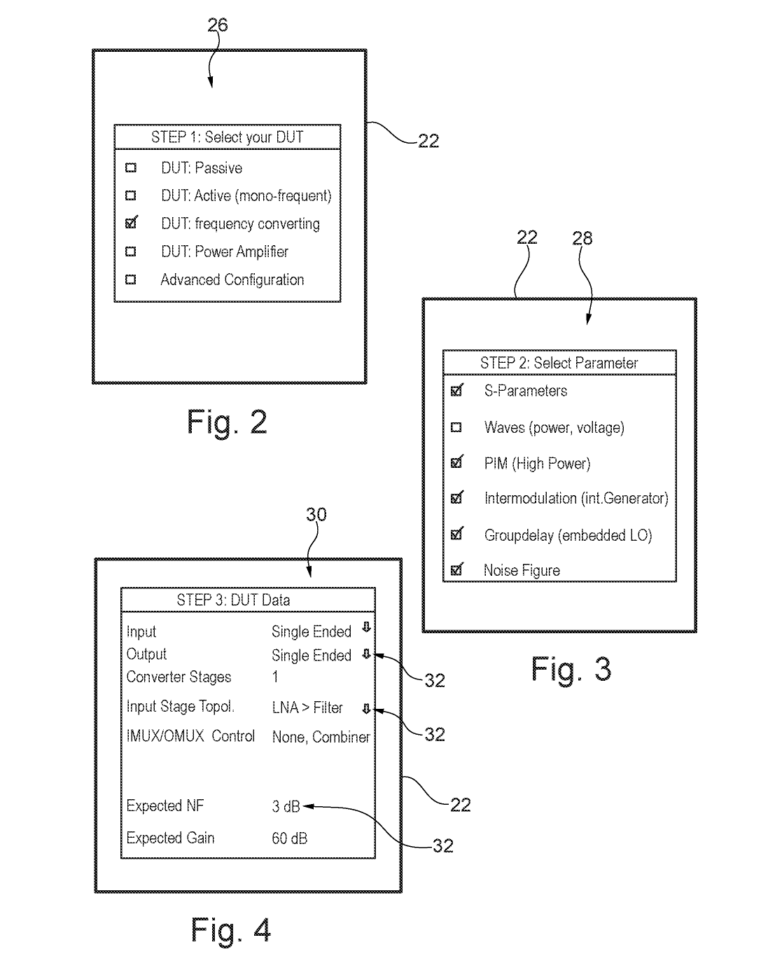

The graphical user interface 24 may comprise several different user interface screen portions that are generated by the processing unit 18 appropriately. Three different user interface screen portions are shown in FIGS. 2 to 4 wherein these user interface screen portions are user interface screens.

Alternatively, at least two screen portions, namely two different graphical user interfaces 24, are displayed simultaneously.

For instance, a first user interface screen 26 (FIG. 2) is provided upon the data provided by the processing unit 18 wherein the first user interface screen 26 comprises a plurality of selectable types of devices under test. Thus, the user may select a certain type of device under test that will be tested by the test and measurement device 14. Accordingly, the user selects the type of device under test that is connected with the test and measurement device 14.

As a device under test may have several different functions, the user may select the main function being of interest for the measurement to be performed. In the shown first user interface screen 26, the user has selected a frequency converting device under test.

Then, a second user interface screen 28 (FIG. 3) is displayed on the display 22 after the selection of the device under test 12.

The second user interface screen 28 provides a plurality of selectable parameters for measurement of the selected device under test 12. Thus, the user can select which measurements have to be performed on the device under test 12.

As shown in FIG. 3, the user is enabled to select several parameters for measurement, also called measurement parameters, simultaneously. Accordingly, the user indicates that he wants to perform several different measurements on the device under test 12. In the shown embodiment, the user wants to measure the scattering parameters (S-Parameters), passive modulation (PIM), Intermodulation, Groupdelay, and Noise Figure as the checkboxes of these parameters are checked.

These different measurements may be (partly) performed simultaneously or subsequently as will be described later.

Afterwards, a third user interface screen 30 (FIG. 4) is displayed on the display 22 wherein the third user interface screen 30 provides controls 32 for input of data being specific for the device under test 12.

In this third user interface screen 30, the user may input specific information regarding the device under test 12, for instance basic information such as start and stop frequencies, power and so on. Furthermore, optional parameters may be inquired by the third user interface screen 30 wherein these optional parameters are indicated as optional ones, for instance by being displayed italic.

In the shown embodiment, information of the device under test 12 is inquired concerning the input, the output, the converter stages, the input stage topology, the Input Multiplexers/Output Multiplexers (IMUX/OMUX) control, the expected Noise Figure (NF), and the expected gain.

The different controls 32 may comprise drop-down menus, value inputs, checkboxes, buttons and other input means to enter the information and data inquired. The information and data input by the user while being guided through these user interface screens 26, 28, 30 are forwarded to the processing unit 18 that interacts with the controller 20.

Based upon the information and inputs of the user, the controller 20 is configured to perform a completely automated configuration of the test and measurement device 14 while setting internal components 34 appropriately such that highly accurate measurements are ensured. Accordingly, a self-configuration of the test and measurement device 14 is provided.

The different characteristics and properties of the internal components of the test and measurement device 14 may be stored such that the controller 20 has access to these parameters. The parameters stored are taking into account while performing the configuration in an automatic manner wherein additional variables are also used. These additional variables relate to the information and inputs of the user.

In other words, formulas relating to the completely automated configuration are used by the controller 20 for configuring the test and measurement device 14 in a completely automatic manner. These formulas may comprise parameters and variables wherein the parameters relate to properties and characteristics of the internal components 34 of the test and measurement device 14, for instance. Thus, these parameters may be pre-set by the manufacturer. Furthermore, the parameters may be adapted by an expert such as a service technician.

Despite the parameters, the formulas used for the completely automated configuration also comprise variables that relate to the information and inputs of the user. Thus, these variables are set while providing the information appropriately.

Accordingly, the test and measurement device 14, in particular the controller 20, is enabled to calculate the required settings for the internal components 34. The parameters of the internal components 34 define their characteristics and properties wherein their settings relate to the desired function.

As the characteristics and properties (parameters) of the internal components 34 are inter alia used by the formulas, no expert knowledge with regard to the internal components 34 is required for setting the internal components 34 in an appropriate manner.

In FIG. 1, these internal components 34 are schematically shown, for instance a low noise amplifier (LNA), filters, an input multiplexer (IMUX) controller, a mixer, an embedded local oscillator, a power amplifier (PA), and an output multiplexer (OMUX) control.

The controller 20 controls these internal components 34 of the test and measurement device 14 that are typically used to perform the measurements intended. For instance, the levels of attenuators, amplifiers are set appropriately. Accordingly, an optimal signal-to-noise ratio/trace noise can be set with regard to the measurement speed.

As the controller 20 controls the several components of the test and measurement device 14 used to perform the measurements selected by the user in an automatic manner, the user does not have to be an expert with regard to the test and measurement device 14 or the measurement itself in order to setup the hardware and software of the test and measurement 14 in appropriate manner. The automatic setup based on the inputs and information of the user ensures a comfortable configuration and highly accurate measurement.

Generally, the different user interface screens 26, 28, 30 provided to the user via the graphical user interface 24 displayed on the display 22 relates to a query process in order to retrieve the information required for establishing the calibration and setup of the test and measurement system 10, in particular the test and measurement device 14.

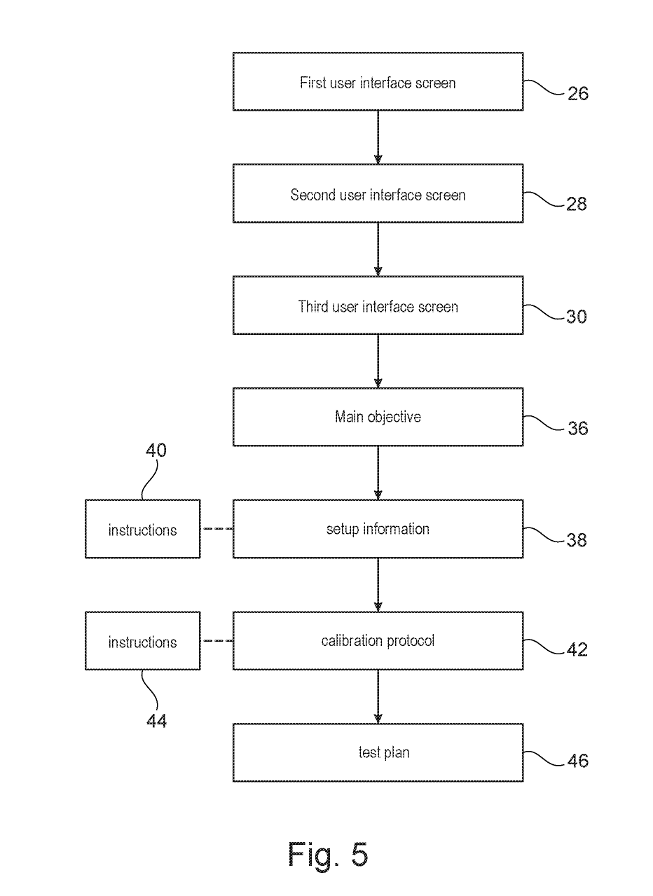

As shown in FIG. 5, these data and information is inquired at the beginning of a measurement while displaying the different user interface screens 26, 28, 30 on the display 22.

Based on these inputs and information provided, the test and measurement device 14 performs an automatic configuration/calibration of the test and measurement device 14 such that high accurate measurements are ensured.

In addition to the three user interface screens 26, 28, 30 shown in FIGS. 2 to 4, a fourth user interface screen 36 may be provided inquiring information regarding the main objective of the measurement(s), for instance high accuracy, fast measurement(s) or tradeoff.

Generally, the user interface screens 26, 28, 30, 36 may be displayed in any order.

Moreover, the display 22 is used to provide information 38 with regard to the setup. This information is also called setup information wherein a proposed setup for interfacing the device under test 12 and the test and measurement device 14 is shown. Furthermore, setup instructions 40 for the user are displayed on the display 22 in order to perform the setup of the whole test and measurement system 10 in the optimal manner. Thus, the user is instructed to connect the device under test 12 with the test and measurement device 14 in an appropriate manner.

Furthermore, the controller 20 may create a proposed calibration protocol 42 in response to the inputs and selections of the user done while inputting the data/information. The proposed calibration protocol 42 ensures an efficient calibration of the test and measurement device 14 for each measurement selected by the user.

In addition, calibration information, in particular instructions 44 to the user, with regard to the calibration process are displayed on the display 22 such that the user can verify the calibration steps proposed by the test and measurement device 14.

Furthermore, the controller 20 may provide a test plan 46 for the device under test 12 such that the several measurements selected are performed in a certain order ensuring the best testing scenario. The test plan 46 may be exported to the user such that the user is enabled to document the setup that results.

In general, the user may select several different measurements wherein the test and measurement device 14 provides a single configuration/calibration in order to ensure the best quality of the several different measurements. Based upon the measurements selected, these measurements may be performed simultaneously (occupying several channels) or subsequently.

Furthermore, the user may select a fast calibration/configuration in order to expedite the process even though the accuracy of the measurement(s) is lowered accordingly. However, the user may focus on other aspects such that a fast measurement is more important than a high accuracy.

Due to the several information and inputs requested by the test and measurement device 14, a fully automatic calibration/configuration and setup of the test and measurement system 10 is ensured, in particular of the test and measurement device 14 itself. Thus, it is no more necessary that the user of the test and measurement device 14 has experience either with the test and measurement device 14 itself or the measurement(s) intended.

Accordingly, an easy and intuitive calibration, configuration and setup of the test and measurement system 10 is ensured enabling the possibility to be used by user having less experience.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A test and measurement device for a device under test, said test and measurement device comprising a processing unit for providing data of a graphical user interface having several user interface screen portions and a display for displaying the user interface screen portions generated by the processing unit, said processing unit being configured to provide:
a first user interface screen portion to the user, said first user interface screen portion comprising a plurality of selectable types of devices under test;
a second user interface screen portion to the user, said second user interface screen portion providing a plurality of selectable parameter for measurement of said selected device under test; and
a third user interface screen portion to the user, said third user interface screen providing controls for input of data being specific for said device under test;
said test and measurement device further comprising a controller, said controller being configured to perform a completely automated configuration of said test and measurement device in response to the inputs and selections of the user in said first through third user interface screen portions, said controller being further configured to provide a proposed setup for interfacing said device under test with said test and measurement device.

2. The test and measurement device according to claim 1, wherein the processing unit generates a fourth user interface screen portion for the user, said fourth user interface screen portion inquiring information about the main objective of said testing.

3. The test and measurement device according to claim 1, wherein said test and measurement device is configured to enable selection of several parameters for measurements simultaneously.

4. The test and measurement device according to claim 1, wherein said inputs comprise at least one of basic information, optional parameters, specifications and expected data of said device under test.

5. The test and measurement device according to claim 4, wherein said optional parameters are identified in said third user interface screen portion as optional ones.

6. The test and measurement device according to claim 1, wherein said controller is further configured to provide setup information in said display about said proposed setup for interfacing said device under test with said test and measurement device.

7. The test and measurement device according to claim 6, wherein said setup information consists of instructions to the user.

8. The test and measurement device according to claim 1, wherein said controller is further configured to create a proposed calibration protocol in response to user inputs and selection in said user interface screen portions, said proposed calibration protocol efficiently calibrating said test and measurement device for each measurement requested by the user.

9. The test and measurement device according to claim 8, wherein said controller is further configured to provide calibration information about said proposed calibration process to the user in said display.

10. The test and measurement device according to claim 9, wherein said calibration information consists of instructions for an optimized calibration.

11. The test and measurement device according to claim 1, wherein said controller is further configured to provide a dedicated test plan for said device under test.

12. The test and measurement device according to claim 11, wherein said controller is further configured to export said test plan to the user.

13. A test and measurement system comprising a device under test to be tested and a test and measurement device according to claim 1.

14. A method for testing a device under test by using a test and measurement device, with the following steps:
providing a device under test;
providing a test and measurement device;
selecting a type of device under test on a graphical user interface of said test and measurement device;
selecting at least one of parameter for measurement of said selected device under test;
inputting data being specific for said device under test;
performing a completely automated configuration of said test and measurement device in response to the inputs and selections of the user in said first through third user interface screen portions; and
providing a proposed setup for interfacing said device under test with said test and measurement device.

15. The method according to claim 14, wherein information about the main objective of said testing is inquired.

16. The method according to claim 14, wherein several parameters for measurements are selected simultaneously.

17. The method according to claim 14, wherein setup information of a proposed setup is provided for interfacing said device under test with said test and measurement device.

18. The method according to claim 14, wherein a proposed calibration protocol is provided by means of said test and measurement device in response to user inputs and selections, said proposed calibration protocol efficiently calibrating said test and measurement device for each measurement requested by the user.

19. The method according to claim 18, wherein calibration information about said proposed calibration process is provided to the user.

20. The method according to claim 14, wherein said test and measurement device is established by a test and measurement device comprising a processing unit for providing data of a graphical user interface having several user interface screen portions and a display for displaying the user interface screen portions generated by the processing unit, said processing unit being configured to provide:
a first user interface screen portion to the user, said first user interface screen portion comprising a plurality of selectable types of devices under test;
a second user interface screen portion to the user, said second user interface screen portion providing a plurality of selectable parameter for measurement of said selected device under test; and
a third user interface screen portion to the user, said third user interface screen providing controls for input of data being specific for said device under test;
said test and measurement device further comprising a controller, said controller being configured to perform a completely automated configuration of said test and measurement device in response to the inputs and selections of the user in said first through third user interface screen portions, said controller being further configured to provide a proposed setup for interfacing said device under test with said test and measurement device.
